(19) United States
(12) Patent Application Publication
(10) Pub. No.: US 2009/0257246 A1
(43) Pub. Date: Oct. 15, 2009

(54) BACK LIGHT MODULE AND DISPLAY APPARATUS USING THE SAME

(75) Inventors: Fu-Min Hsu, Taichung County (TW); Tien-Nan Wang, Taichung County (TW); Chin-Liang Chen, Taichung City (TW); Chen-Shao Lu, Taichung City (TW); Ming-Da Chen, Taichung County (TW); Chin-Wei Huang, Changhua County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: WINTEK CORPORATION, Taichung (TW)

(21) Appl. No.: 12/421,006

(22) Filed: Apr. 9, 2009

(30) Foreign Application Priority Data
Apr. 15, 2008 (TW) 97113695

(51) Int. Cl. F21V 15/015

(52) U.S. Cl. 362/633

(57) ABSTRACT

A back light module including a frame, a light-guide plate and a light source is provided. The frame has a opening and a first surface and a second surface opposite to the first surface. The opening is extended from the first surface to the second surface of the frame, so that an inner surface of the opening is connected to the first surface and the second surface. At least a portion of the inner surface is slanted toward the inner of the opening. The light-guide plate is integrated with the frame and at least a portion of the opening is filled with the light-guide plate. The light-guide plate is tightly attached to the inner surface of the frame. The light source is adjacent to the light-guide plate.

This application claims the benefit of Taiwan application Serial No. 97113695, filed Apr. 15, 2008, the subject matter of which is incorporated herein by reference.

### BACKGROUND OF THE INVENTION

1. Field of the Invention

The invention relates in general to a back light module and a display apparatus using the same, and more particularly to an easy-to-manufacture back light module and a display apparatus using the same.

2. Description of the Related Art

The liquid crystal display apparatus mainly includes a display panel and a back light module. The small-sized display panel normally adopts an edge lighting back light module. The edge lighting back light module is normally disposed under the display panel and at least includes a light-guide plate and a frame. According to the current method of manufacturing the display apparatus, the light-guide plate and other optical elements are disposed on the frame or other corresponding parts after the frame is manufactured.

According to the above method, two manufacturing processes are required for manufacturing the light-guide plate and the frame respectively, hence requiring more facility cost. Furthermore, the assembly of the light-guide plate and the frame incurs additional time and cost in assembly and the structural strength of the assembled display apparatus still cannot guarantee that the display apparatus will not disintegrate when receiving a heavy concussion. Also, if the light-guide plate is disposed on the frame, the coupling mechanism of the light-guide plate will hinder the light and deteriorate optical visual effect. Thus, the current method of manufacturing the frame and the light-guide plate still much need to improve in terms of manufacturing hours, cost, and lifespan and so on.

### SUMMARY OF THE INVENTION

The invention is directed to an easy-to-manufacture back light module and a display apparatus using the same. The frame and the light-guide plate are integrated, not only saving time and cost for assembling but also increase the structural strength of the back light module and the display apparatus using the same.

According to a first aspect of the present invention, a back light module including a frame, a light-guide plate and a light source is provided. The frame has a opening and a first surface and a second surface opposite to the first surface. The opening is extended from the first surface to the second surface of the frame, so that an inner surface of the opening is connected to the first surface and the second surface. At least a portion of the inner surface is slanted toward the inner of the opening. The light-guide plate is integrated with the frame and at least a portion of the opening is filled with the light-guide plate. The light-guide plate is tightly attached to the inner surface of the frame. The light source is adjacent to the light-guide plate.

According to a second aspect of the present invention, a display apparatus including a display panel and a back light module as the above-mentioned is provided. The display panel adjacent to the light-guide plate for displaying a image.

The invention will become apparent from the following detailed description of the preferred but non-limiting embodiments. The following description is made with reference to the accompanying drawings.

### BRIEF DESCRIPTION OF THE DRAWINGS

FIG. 1 shows a schematic of a display apparatus according to a preferred embodiment of the invention;

FIG. 2 shows a schematic of a back light module of the display apparatus of FIG. 1;

FIG. 3 shows a schematic of a frame of the back light module of FIG. 1;

FIG. 4 shows a cross-sectional view of the display apparatus of FIG. 1 viewed along a cross-sectional line 1A-1A′;

FIG. 5A shows a cross-sectional contour of an inner surface of the frame being a trapezoid;

FIG. 5B shows a cross-sectional contour of an inner surface of the frame being a cone;

FIG. 6 shows a partial enlargement of the region C of FIG. 3;

FIG. 7 shows a schematic of another disposition of the back-stop opening of the frame;

FIG. 8A shows a cross-sectional view of the back-stop opening of FIG. 7 viewed along a cross-sectional line 1B-1B′;

FIG. 8B shows a 3-D schematic of the back-stop opening of FIG. 8A;

FIG. 9A shows a schematic of yet another disposition of the back-stop opening of the frame; and

FIG. 9B shows a 3-D schematic of the back-stop opening of FIG. 9A.

### DETAILED DESCRIPTION OF THE INVENTION

An easy-to-manufacture back light module and a display apparatus using the same are disclosed in the invention. The frame and the light-guide plate are integrated, not only saving time and cost in assembly but also increasing the structural strength of the back light module and the display apparatus using the same. A preferred embodiment is disclosed below. However, the embodiment is merely an exemplification of the spirit of the invention, and the elaboration and drawings used in the embodiment are not for limiting the scope of protection of the invention.

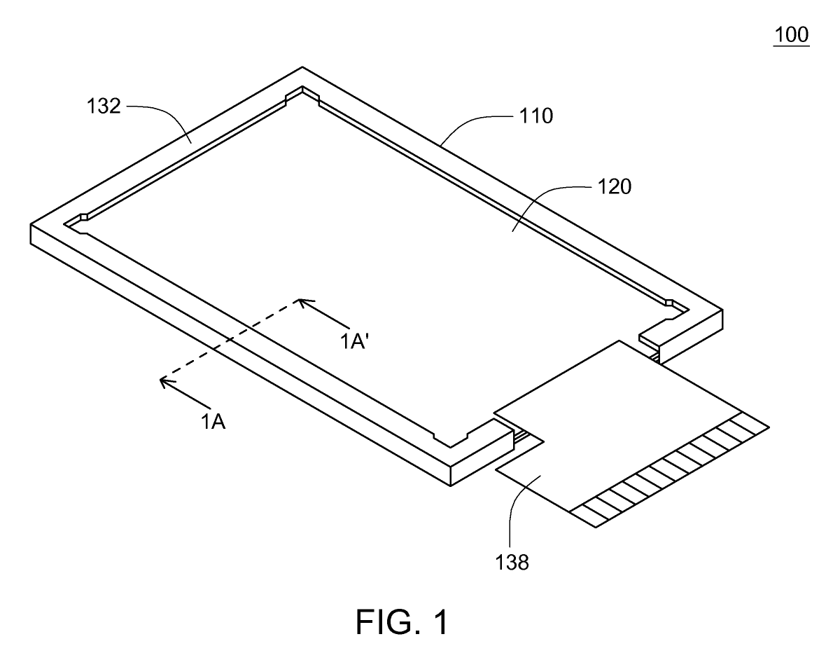

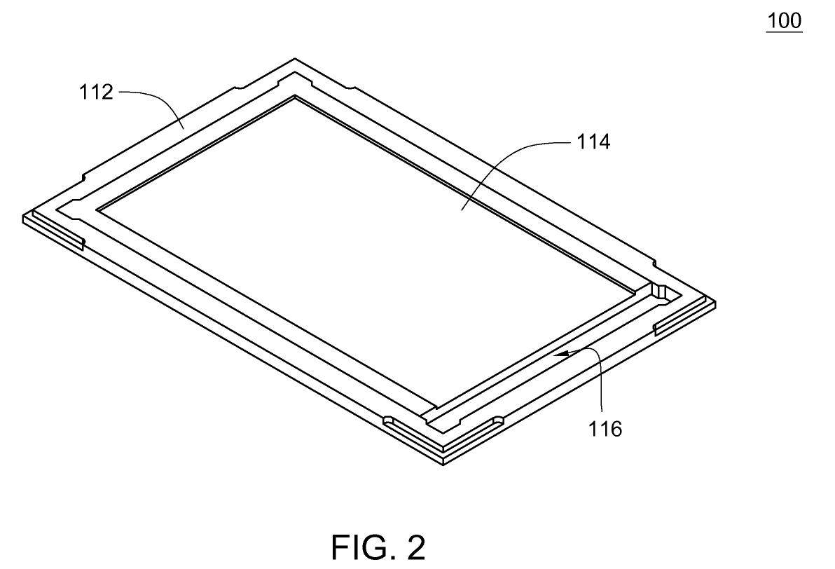

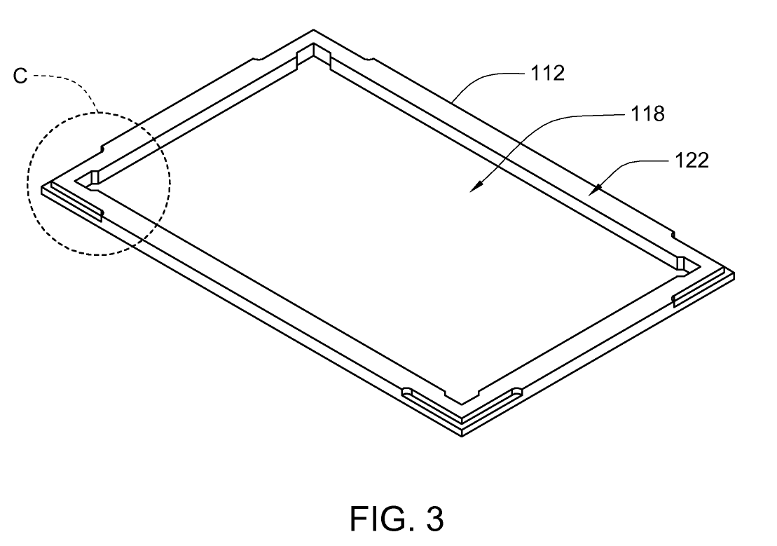

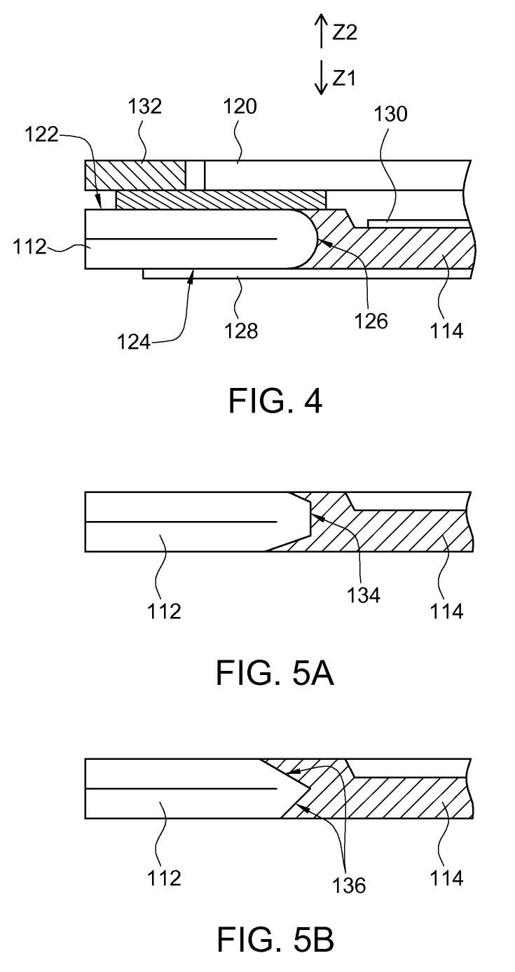

Referring to FIG. 1, a schematic of a display apparatus according to a preferred embodiment of the invention is shown. The display apparatus 100 includes a back light module 110, a display panel 120 and a circuit board 138. The circuit board 138 is preferably a flexible circuit board used for transmitting a signal for controlling the back light module 110 and the display panel 120. Referring to FIG. 2 and FIG. 3. FIG. 2 shows a schematic of a back light module of the display apparatus of FIG. 1. FIG. 3 shows a schematic of a frame of the back light module of FIG. 1. As indicated in FIG. 2, the back light module 110 includes a frame 112, a light-guide plate 114 and a light source (not illustrated). As indicated in FIG. 3, the frame 112 has a opening 118 and a first surface 122 and a second surface 124 (the second surface 124 is illustrated in FIG. 4) opposite to the first surface 122. The opening 118 is extended from the first surface 122 to the second surface 124 of the frame 112. The light-guide plate 114 is integrated with the frame 112 and at least a portion of the opening 118 is filled with the light-guide plate 114. The light source is adjacent to the light-guide plate 114. That is, the light-guide plate 114 only fills a portion of the opening 118 not the whole of the opening 118. There is a gap 116 between the light-guide plate 114 and an inner side of the frame 112, wherein the light source is disposed in the gap 116 such that a light of the light source enters the light-guide plate 114 from a side of the light-guide plate 114. Preferably, the light-guide plate 114 is made from a plastics having high transparency, such that the luminance loss is reduced after the light of the light source passes through the light-guide plate 114. The display panel 120 is adjacent to the light-guide plate 114 for displaying a frame. Referring to FIG. 4, a cross-sectional view of the display apparatus of FIG. 1 viewed along a cross-sectional line 1A-1A is shown. The opening 118 of the frame 112 has an inner surface 126, and the light-guide plate 114 is tightly coupled to the inner surface 126. The inner surface 126 connects the first surface 122 to the second surface 124. At least a portion of the inner surface 126 is slanted toward the inner of the opening 118. In the present embodiment of the invention, the cross-sectional contour of the inner surface is arc-shaped.

Besides, the display apparatus 100 further includes a reflector 128 and a brightness enhancement film (BEF) 130. The reflector 128 is disposed under the light-guide plate 114 for reflecting the light to the light-guide plate 114. The BEF 130 is disposed between the light-guide plate 114 and the display panel 120 for enabling the light to be concentrated and radiated onto the display panel 120.

Besides, the display apparatus 100 further includes a light shielding plate 132. The light shielding plate 132 is disposed on a part or the whole of the first surface 122 of the frame 112 for shielding the unattractive boundary between the frame 112 and the display panel 120. The light shielding plate 132 further protects the first surface 122.

In the present embodiment of the invention, the frame 112 is a metallic plate, the cross-sectional contour of the inner surface 126 is an arc which is formed by bending an edgefold of the metallic plate and attaching the edgefold onto the metallic plate tightly. Moreover, the cross-sectional contour of the inner surface can also have other shapes such as a trapezoid 134 or a cone 136. Referring to FIG. 5A and FIG. 5B. FIG. 5A shows a cross-sectional contour of an inner surface of the frame being a trapezoid. FIG. 5B shows a cross-sectional contour of an inner surface of the frame being a cone. No matter what shape of the inner surface is, as long as the light-guide plate fills the slanted space at the two sides of the inner surface and is thus engaged with the frame 112, the light-guide plate 114 will not shift towards the directions Z1 and Z2. The directions Z1 and Z2 are indicated in FIG. 4.

The cross-sectional contour of the inner surface of the frame 112 can be made arc-shaped by way of stamping and bending. Or, the inner surface of the frame 112 can be shaped into a predetermined contour such as a plane or an arced place by way of rolling or cutting after the frame is formed by way of stamping or casting. Moreover, the frame 112 and the predetermined inner surface can be integrally formed by way of stamping and molding.

Furthermore, inclination angles at the two sides of the inner surface could be different. As indicated in FIG. 5A, the inner surface 134 whose cross-sectional contour is trapezoidal can have different inclination angles at the two sides. Or, as indicated in FIG. 5B, the inner surface 134 whose cross-sectional contour is conic, can have different inclination angles at the two sides. Thus, the area of the opening 118 on the first surface 122 is not equal to the area of the opening 118 on the second surface 124.

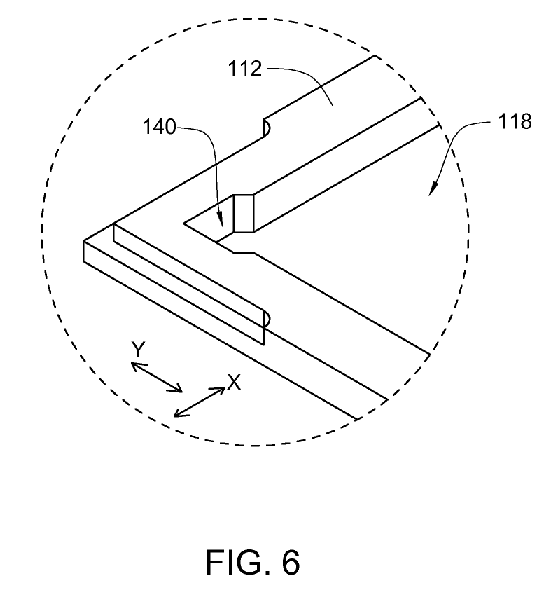

Referring to FIG. 6, a partial enlargement of the region C of FIG. 3 is shown. The opening 118 is substantially a rectangle (as indicated in FIG. 3). The back-stop opening 140 is extended from the first surface 122 to the second surface 124 of the frame 112, and is disposed at a corner of the rectangle. Thus, when the light-guide plate 114 shifts towards the directions X and Y, a back stop effect is generated. When incorporated with the inner surface of the present embodiment of the invention, the light-guide plate 114 will not shift towards the directions X, Y, Z1 and Z2. In the present embodiment of the invention, the back-stop opening is extended from the first surface 122 to the second surface 124 of the frame 112. However, in other embodiments, the back-stop opening 140 can be a slot (not illustrated) disposed on at least one of the first surface 122 and the second surface 124 without passing through the first surface 122 and the second surface 124. Besides, there can be more than one back-stop opening 140. Preferably, there are two back-stop openings 140 disposed at any two corners of the opening.

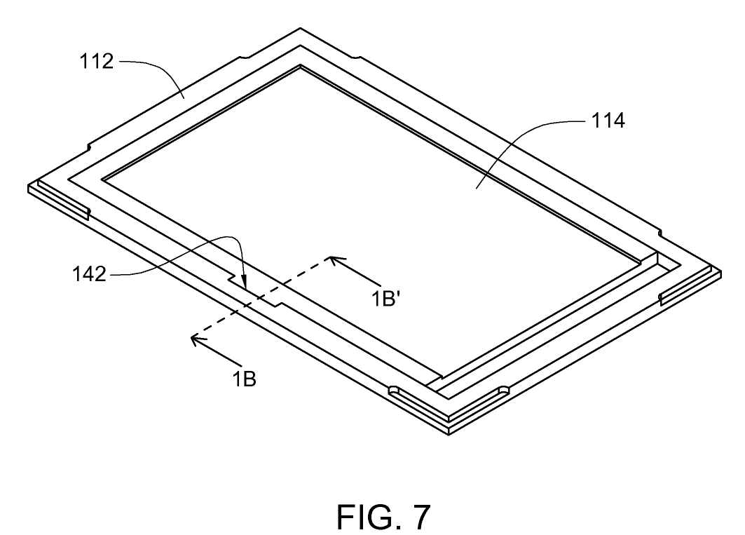

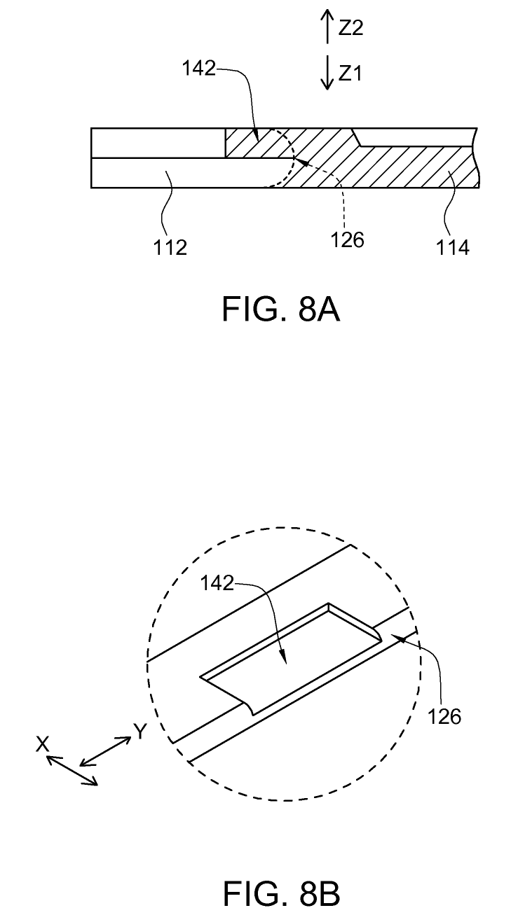

Besides, the back-stop opening can also be disposed at a position other than the corners. Referring to FIG. 7, a schematic of another disposition of the back-stop opening of the frame is shown. The back-stop opening 142 is adjacent to an edge of the opening 118. For example, the back-stop opening 142 is adjacent to the left edge. Referring to FIG. 8A and FIG. 8B. FIG. 8A shows a cross-sectional view of the back-stop opening of FIG. 7 viewed along a cross-sectional line 1B-1B′. FIG. 8B shows a 3-D schematic of the back-stop opening of FIG. 8A. As indicated in FIG. 8A, the light-guide plate 114 is partly extended to the back-stop opening 142 and the back-stop opening 142 is filled with a portion of the light-guide plate 114. As indicated in FIG. 8B, the back-stop opening 142 stops the light-guide plate 114 shifting towards the directions X and Y Thus, the back-stop opening 142 incorporated with the inner surface 126 stops the light-guide plate 114 shifting towards the directions X, Y, Z1 and Z2.

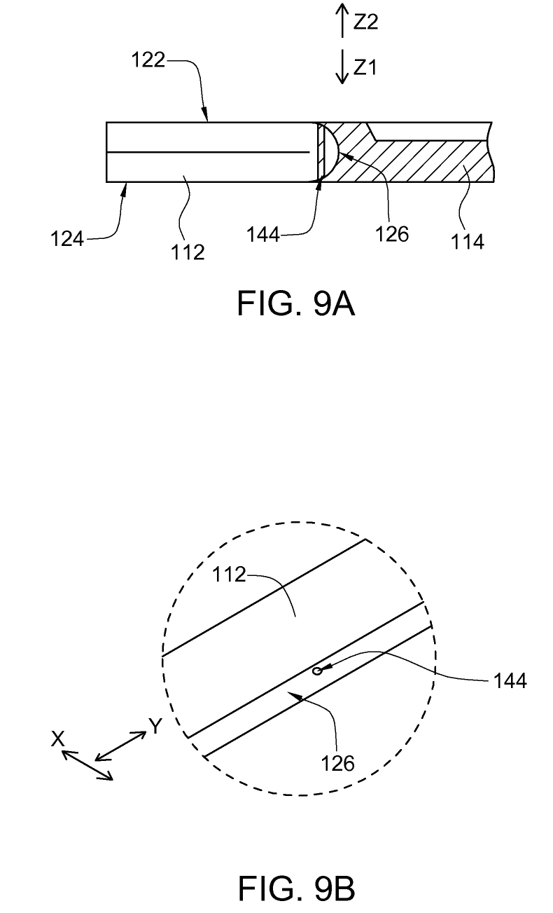

Referring to FIG. 9A and FIG. 9B. FIG. 9A shows a schematic of yet another disposition of the back-stop opening of the frame. FIG. 9B shows a 3-D schematic of the back-stop opening of FIG. 9A. As indicated in FIG. 9B, the back-stop opening 144 is adjacent to an edge of the opening 118, such as the left edge for example, and is further extended from the first surface 122 to the second surface 124 of the frame 112. The light-guide plate 114 is partly extended to the back-stop opening 142 and the back-stop opening 144 is filled with a portion of the light-guide plate 114. Thus, the back-stop opening 144 stops the light-guide plate 114 shifting towards the directions X and Y. That is, the back-stop opening 144 incorporated with the inner surface 126 stops the light-guide plate 114 shifting towards the directions X, Y, Z1 and Z2.

The quantity of the back-stop openings 142 and 144 is not limited to be one. Preferably, there are several back-stop openings respectively disposed at each edge of the opening 118. Or, there are several back-stop openings 142 and 144 disposed at an edge of the opening.

In the present embodiment of the invention, the opening shape of the back-stop opening 140 and 142 is rectangular, and the opening shape of the back-stop opening 144 is circular. However, in other embodiments, the opening shape of the back-stop opening is not limited to be rectangular or circular. The opening shape of the back-stop opening can even be irregular. The quantity, position and shape of the back-stop opening can have variable combination as long as the back-stop opening stops the light-guide plate 114 shifting towards the directions X, Y, Z1 and Z2 and are not limited to the exemplification of the embodiment.

The easy-to-manufacture back light module and the display apparatus using the same disclosed in the above embodiment of the invention have the following advantages:

1). The frame and the light-guide plate are integrated, not only saving assembly time and assembly cost but also increasing the structural strength of the display apparatus.

2). As the frame and the light-guide plate are integrated, the light-guide plate no longer require coupling mechanism for assembly and the optical visual effect is made even better.

3). The back-stop opening stops the light-guide plate shifting towards the directions X, Y, Z1 and 72, further enhancing the firmness of the light-guide plate and the frame.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. Aback light module, comprising:
a frame having a opening and a first surface and a second surface opposite to the first surface, the opening is extended from the first surface to the second surface of the frame, an inner surface of the opening is connected to the first surface and the second surface, and at least a portion of the inner surface is slanted toward the inner of the opening;
a light-guide plate integrated with the frame, wherein at least a portion of the opening is filled with the light-guide plate and the light-guide plate is tightly attached to the inner surface of the frame; and
a light source disposed adjacent to the light-guide plate.

2. The back light module according to claim 1, wherein a cross-sectional contour of the inner surface is arc-shaped.

3. The back light module according to claim 2, wherein the frame is a metallic plate, and the arc-shaped cross-section is formed by bending an edgefold of the metallic plate and attaching the edgefold onto the metallic plate tightly.

4. The back light module according to claim 1, wherein the area of the opening on the first surface is not equal to the area of the opening on the second surface.

5. The back light module according to claim 4, wherein a cross-sectional contour of the inner surface is conic or a trapezoidal.

6. The back light module according to claim 1, wherein the frame is a stamping piece or a casting piece and the light-guide plate is made from a plastics having high transparency.

7. The back light module according to claim 1, wherein the frame further comprises:
a back-stop opening adjacent to the opening, wherein the light-guide plate is partly extended to the back-stop opening and the back-stop opening is filled with a portion of the light-guide plate.

8. The back light module according to claim 7, wherein the opening shape of the opening is substantially rectangular, and the position of the back-stop opening corresponds to a corner of the rectangle.

9. The back light module according to claim 7, wherein the back-stop opening is adjacent to an edge of the opening.

10. The back light module according to claim 1, wherein a portion of the opening is filled with the light-guide plate, there is a gap between the light-guide plate and an inner side of the frame, and the light source is disposed in the gap, such that a light of the light source enters from a side of the light-guide plate.

11. A display apparatus, comprising:
a back light module, comprising:
a frame having a opening and a first surface and a second surface
opposite to the first surface, the opening is extended from the first surface to the second surface of the frame, the frame has an inner surface connected to the first surface and the second surface in the opening, and at least a portion of the inner surface is slanted toward the inner of the opening;
a light-guide plate integrated with the frame, wherein at least a portion of the opening is filled with the light-guide plate and the light-guide plate is tightly attached to the inner surface of the frame; and
a light source disposed adjacent to the light-guide plate; and
a display panel adjacent to the light-guide plate for displaying a image.

12. The display apparatus according to claim 11, wherein a cross-sectional contour of the inner surface is arc-shaped.

13. The display apparatus according to claim 12, wherein the frame is a metallic plate, and the arc-shaped cross-section is formed by bending an edgefold of the metallic plate and attaching the edgefold onto the metallic plate tightly.

14. The display apparatus according to claim 11, wherein the area of the opening on the first surface is not equal to the area of the opening on the second surface.

15. The display apparatus according to claim 11, wherein a cross-sectional contour of the inner surface is conic or a trapezoidal.

16. The display apparatus according to claim 11, wherein the frame is a stamping piece or a casting piece and the light-guide plate is made from a plastics having high transparency.

17. The display apparatus according to claim 11, wherein the frame further comprises:
a back-stop opening adjacent to the opening, wherein the light-guide plate is partly extended to the back-stop opening and the back-stop opening is filled with a portion of the light-guide plate.

18. The display apparatus according to claim 17, wherein the opening shape of the opening is substantially rectangular, and the position of the back-stop opening corresponds to a corner of the rectangle.

19. The display apparatus according to claim 17, wherein the back-stop opening is adjacent to an edge of the opening.

20. The display apparatus according to claim 11, wherein a portion of the opening is filled with the light-guide plate, there is a gap between the light-guide plate and an inner side of the frame, and the light source is disposed in the gap, such that a light of the light source enters from a side of the light-guide plate.
